(19) United States
(12) Patent Application Publication
(10) Pub. No.: US 2008/0044717 A1
(43) Pub. Date: Feb. 21, 2008

(54) PORTABLE POWER SUPPLY DEVICE WITH A FUEL CELL

(75) Inventors: Justin C.P. CHOU, Hsinchu City (TW); Chien-Fu Kuo, Taichung City (TW); Po-Han Huang, Taipei City (TW); Ming-Hsuan Huang, Hsinchu City (TW); Shih-Tsung Ke, Siaying Township (TW); Tsong-Pyng Perng, Hsinchu (TW)

Correspondence Address: EGBERT LAW OFFICES, 412 MAIN STREET, 7TH FLOOR, HOUSTON, TX, 77002, US

(73) Assignee: NATIONAL TSING HUA UNIVERSITY, Hsinchu (TW)

(21) Appl. No.: 11/466,075

(22) Filed: Aug. 21, 2006

(51) Int. Cl. H01M 8/02; H01M 8/04

(52) U.S. Cl. 429/38; 429/90

(57) ABSTRACT

The present invention provides a portable power supply device with a fuel cell. The device includes a main body with predefined internal and exterior parts. A fuel cell stack is mounted onto a predefined location of the main body. A fuel supplier is mounted at a preset location of the main body. A control switch is mounted at a predefined location of main body for switching the fuel cell stack on and off. A transformer system is used to convert DC of the fuel cell stack into AC. At least one AC socket is mounted onto a preset location of the main body. The portable power supply device of the present invention offers a longer lasting power supply via a fuel cell stack. The portable power supply device is an environment-friendly and weather-proof power generating system for currently used electronics.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates generally to a portable power supply device with a fuel cell, and more particularly to an innovative power supply device with a transformer system, which can provide an AC socket for various electronics.

### BACKGROUND OF THE INVENTION

Energy independence has been an important economic consideration of countries worldwide for a long time. In recent years, the increase in oil price has raised a serious concern with respect to alternative energy and has also driven countries to actively develop alternative energy technologies. The founder of Ballard Power Systems, Dr. Geoffrey Ballard in 2002 stressed that: “We must guarantee [a] sufficient and sustainable energy supply in order to develop and improve the level of medicine, science, education and social responsibility as well as standard of living.” Therefore, an alternative energy source is a necessity in view of the declining oil supply.

Today, wind energy, solar energy and nuclear energy are well-known alternative energy sources. For instance, many member countries of the EU have developed wind and solar power facilities. Specifically, the electricity from wind energy is less than 1% of worldwide power consumption, but accounts for 20% of power consumption in Denmark. New wind power generators are installed in the EU every year, e.g. 570 GW power generator units in 2004. However, wind energy and solar energy are vulnerable to weather conditions and are restricted in terms of being used as a power supply. In another example, the government of Iceland is committed to developing hydrogen energy by virtue of abundant hydraulic power and terrestrial heat, in combination with fuel cells.

As a power generating system, a fuel cell converts chemical energy into electrical energy using an oxidation-reduction reaction of hydrogen and oxygen. Since this process does not yield any CO₂, many fuel cell systems were developed by some developed countries long time ago, such as solid oxygen fuel cell, referred to as “SOFC”, for large-scale power generating systems, and proton exchange membrane fuel cell, referred to as “PEMFC” for small stationary power generating systems in lieu of vehicle engines, and direct methanol fuel cell, referred to as “DMFC” for 3C electronic power supply modules. Moreover, the hydrogen required for a fuel cell contributes to reduce oil consumption while minimizing emission of CO₂.

A portable fuel cell is a small power generating system, which is able to energize 3C electronics continuously in the presence of sufficient fuel. At present, many Japanese corporations, such as Toshiba, NEC and NTT Docomo, have developed fuel cells, and Antig Technology in Taiwan has also successfully developed a DMFC for notebook computers, presenting a possible trend of commercialization of portable fuel cells.

Unlimited power supply is a key factor to further development of 3C electronic products; they enable a higher standard of living at anytime and anywhere, and allow people to keep connected with their friends and family during travel. Therefore, the technology development of a portable fuel cell may help changing people's living habits. In contrast, climatic and geographical factors have placed a bigger restriction on solar cell in terms of portable or alternative power source.

Customization of a power supply requires a costly and time-consuming process because the variety of electronics with different power supply specifications is extensive. Today, portable fuel cells are restricted to a specific design not common to or shared with other electronics. Thus, existing portable fuel cells cannot meet people's demanding requirements of power supply when they carry multiple different electronics, such as a laptop computer, digital camera, PDA, mobile phone and MP3 player, etc.

Thus, to overcome the aforementioned problems of the prior art, it would be an advancement in the art to provide an improved portable power supply device with a fuel cell, which can supply power to various electronics.

To this end, the inventor has provided the present invention of practicability after deliberate design and evaluation based on his years of experience in the production, development and design of related products.

### BRIEF SUMMARY OF THE INVENTION

The portable power supply device A of the present invention offers longer lasting power supplies via a fuel cell stack 20 and also serves as an environment-friendly and weather-proof power generating system. Based on the transformer system 50 and AC socket 60 of the present invention, this portable power supply device can be used by different current electronics, thus improving the standard of living for people using these electronics.

The portable power supply device A of the present invention can be easily folded. The device has a compact design, wherein a main body 10 includes an expandable first part 11 and second part 12.

The portable power supply device A of the present invention can be installed onto predefined objects (e.g. shoulder bags) when the main body 10 is fitted with fixtures (e.g. fastener 14, hooker 15, snapper).

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows a perspective view of the preferred embodiment of the portable power supply device.

FIG. 2 shows a perspective view of the portable power supply device in a folded state.

FIG. 3 shows a schematic drawing of the transformer system for frequency conversion.

FIG. 4 shows another schematic drawing of the transformer system for frequency conversion.

FIG. 5 shows a schematic drawing of the frequency converting circuit of the transformer system.

FIG. 6 shows another schematic drawing of the frequency converting circuit of the transformer system.

FIG. 7 shows a perspective view of the portable power supply device coupled with a shoulder bag.

FIG. 8 shows another perspective view of the portable power supply device together with fixtures.

FIG. 9 shows a perspective view of the portable power supply device fitted with a DC socket.

FIG. 10 shows a perspective view of the portable power supply device compatible with many different electronics.

### DETAILED DESCRIPTION OF THE INVENTION

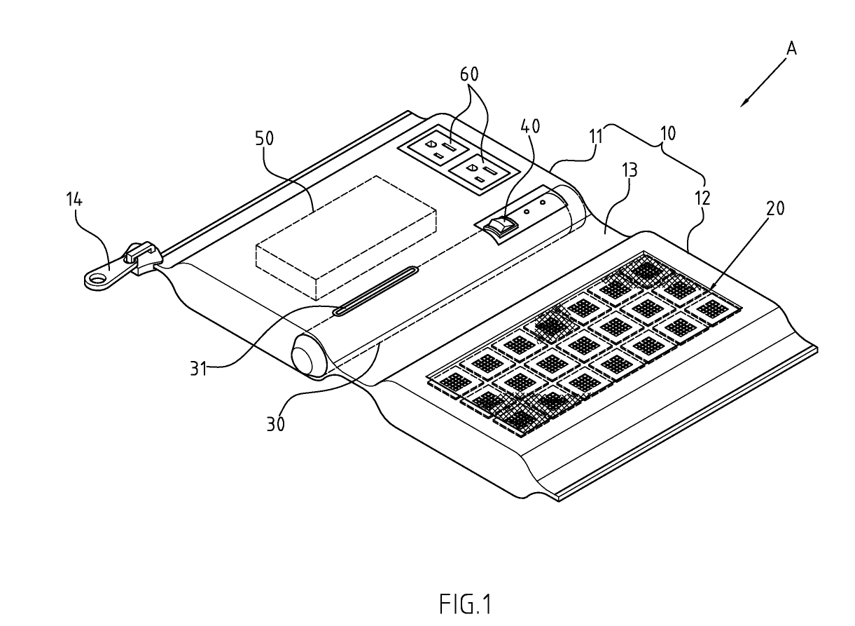

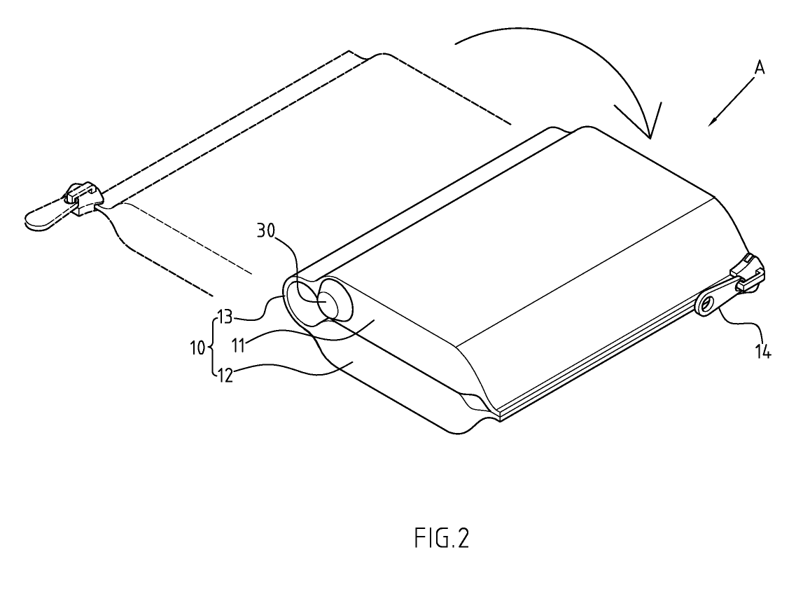

FIGS. 1 and 2 depict a preferred embodiment of the present invention, being provided only for explanatory purposes for the patent claims.

The portable power supply device A comprises a main body 10 with predefined internal and exterior parts. The main body 10 of the present invention comprises an expandable first part 11 and second part 12, both of which are connected by a flat flexible part 13 (as illustrated in FIG. 2). This main body 10 is coated with a waterproof fabric layer, such as non-woven fabric. The main body 10 ensures user-friendly operation with its unique features.

The invention also includes a fuel cell stack 20, which is mounted onto a predefined location of the main body 10. The fuel cell stack 20 of the present invention is horizontally placed in series, presenting a flat configuration. With regard to existing portable electronics, such as PCs, digital cameras, PDAs and mobile phones, the power required is less than 20 W. Thus, fifteen 4 cm2 batteries are connected in series to achieve 5V voltage output for the fuel cell stack 20. If the average operating voltage of a battery is about 0.3V-0.4V with constant current of 4 A, 20 W output power can be achieved.

A fuel supplier 30 is mounted at a preset location of the main body 10, thereby supplying power to the fuel cell stack 20. The fuel supplier 30 of the present invention is a hydrogen tank, which is placed between the first part 11 and flexible part 13 of the main body 10. The hydrogen tank is made of LaNi-based or other series of a hydrogen storage alloy, with a release pressure between 1-3 atm. When hydrogen is released, the hydrogen storage alloy yields a heat-absorption reaction and requires a thermal exchange with a stuffy ambient environment. In addition to the hydrogen tank, the fuel supplier 30 may also be an alcohol tank. The fuel supplier 30 is externally provided with a fuel indicator 31, such that the users can visualize and fill with hydrogen. The fuel indicator 31 is designed with many variants depending upon the fuel, such as a transparent window and pressure gauge.

A control switch 40 is mounted at a predefined location of main body 10 for switching the fuel cell stack 20 on and off.

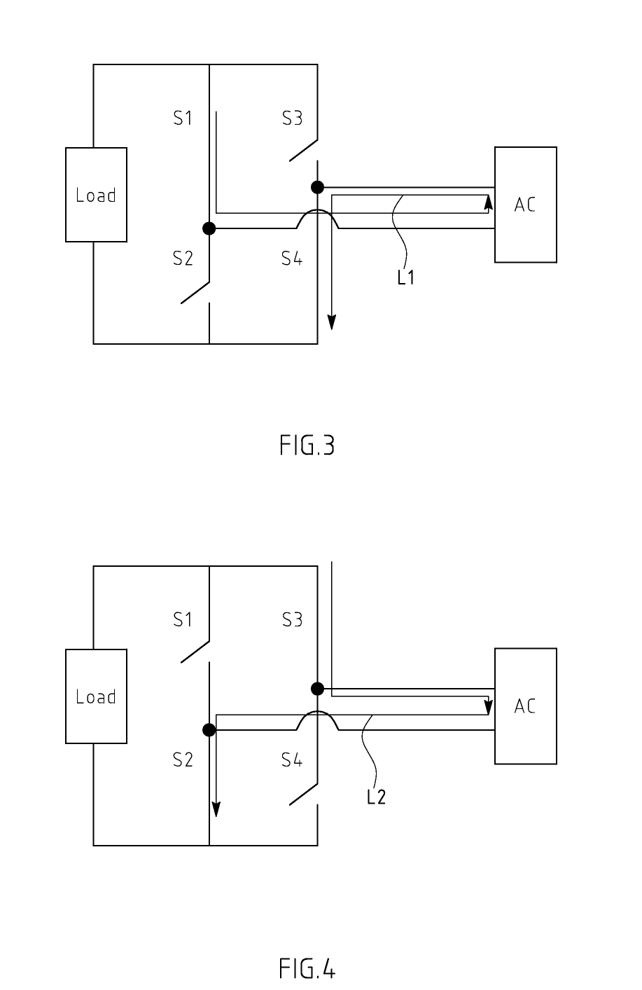

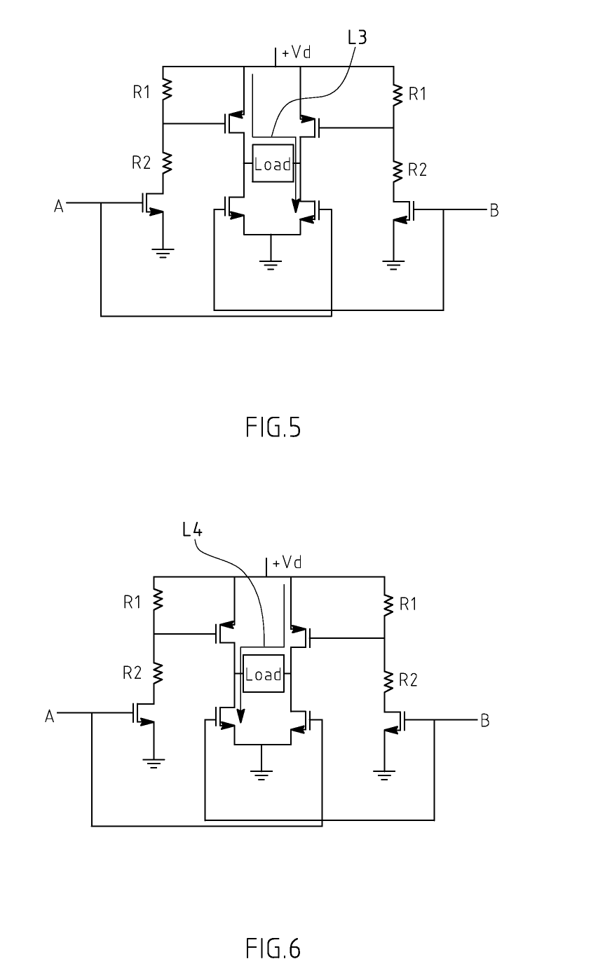

A transformer system 50 is used to convert DC of the fuel cell stack into AC. Given a preset output voltage of about 5V, a voltage increase and frequency conversion shall be required to achieve a 110V AC output. The frequency conversion is described herein below (FIGS. 3-6). After voltage is increased, the load will be changed into 110V DC, where the load is connected to four switches. When S1 and, S4 are energized, the circuit is marked by L1 in FIG. 3. When S2 and, S3 are energized, the circuit is marked by L2 in FIG. 4. In such a way, the previous 110V DC is converted into 110V AC. An actual circuit diagram is illustrated in FIG. 5. When A is charged with a high voltage, the circuit is marked by L3. When B is charged with a high voltage, the circuit is marked by L4 in FIG. 6, thus generating an AC.

An AC socket 60 is mounted onto a preset location of the main body 10. The AC socket 60 is linked to transformer system 50, serving as an outlet of AC.

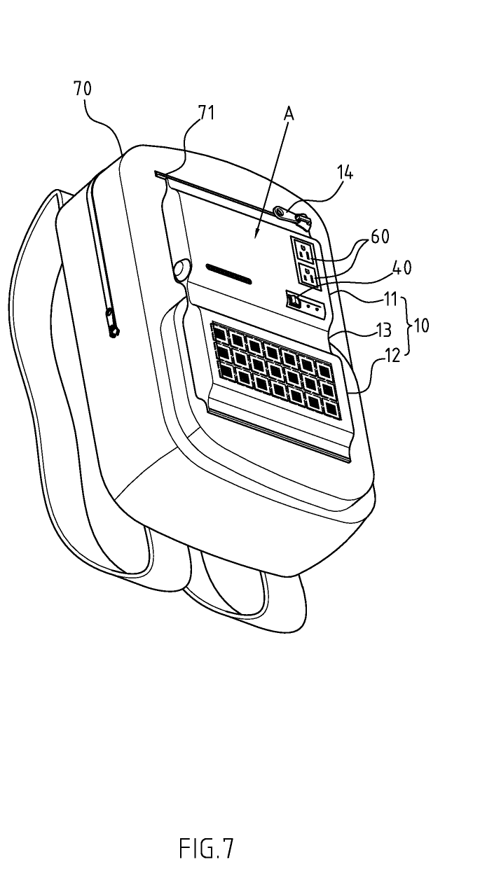

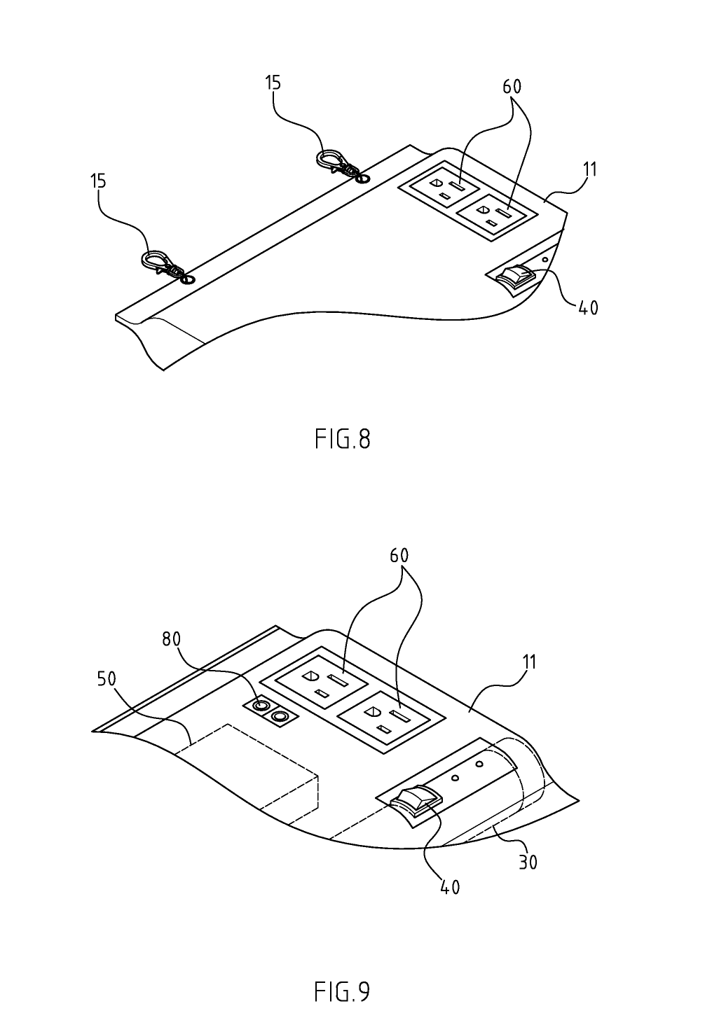

The main body 10 is also fitted with a fixture, which is designed with many variants. As illustrated in FIG. 1, the fixture is a fastener 14 mounted laterally onto the first part 11 of the main body 10, such that the object is shaped like a shoulder bag 70 (referring to FIG. 7). The shoulder bag 70 is provided with a fastener chain 71, which is combined with a fastener 14. So, the portable power supply device A can be coupled with a shoulder bag 70, offering convenient carrying and easy removal. As illustrated in FIG. 8, the fixture is a hooker 15 for the same purpose. In addition, the fixture can also be a snapper (e.g. male and female snappers of a back-strap).

Referring to FIG. 9, the main body 10 is externally provided with a DC socket 80, in addition to an AC socket 60. The DC socket is linked to the fuel cell stack 20, serving as a DC outlet of the fuel cell stack.

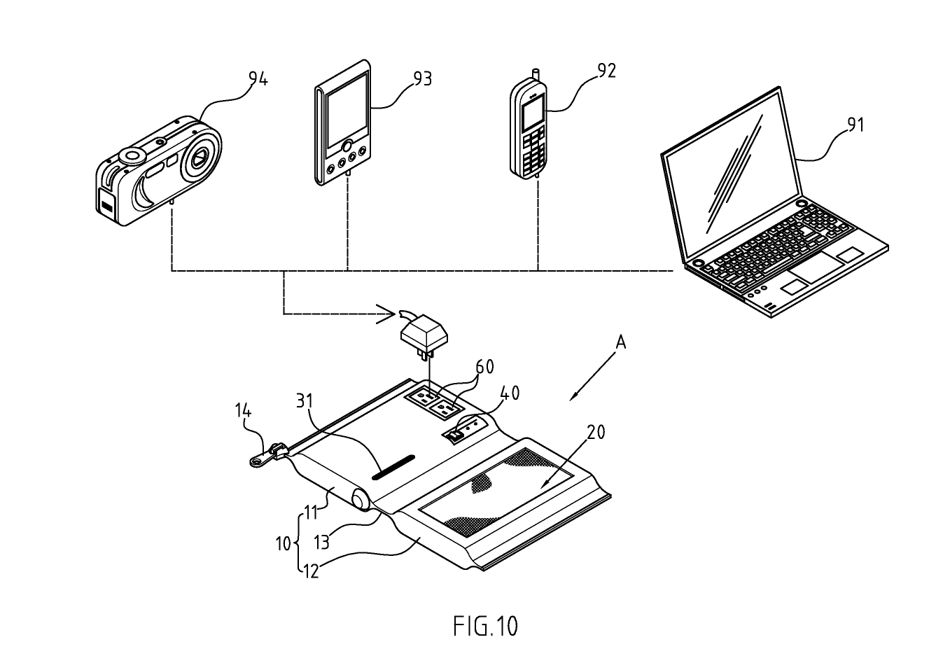

Portable power supply device A of the present invention can be linked to most of 3C electronics, such as PC 91, mobile phone 92, PDA 93 and digital camera 94 (referring to FIG. 10).

We claim:

1. A portable power supply device with a fuel cell, said portable power supply device comprising:
a main body with predefined internal and exterior parts;
a fuel cell stack mounted onto a predefined location of said main body;
a fuel supplier being mounted at a preset location of said main body and supplying fuel to said fuel cell stack;
a control switch, being mounted at a predefined location of said main body and switching said fuel cell stack on and off;
a transformer system used to convert DC of said fuel cell stack into AC; and
at least one AC socket, being mounted onto a preset location of said main body and being linked to said transformer system, serving as an outlet of AC.

2. The device defined in claim 1, further comprising:
a plurality of fuel cells being fitted in said main body, said main body being comprised of an expandable first part and second part.

3. The device defined in claim 1, further comprising:
fixtures being fitted in said main body, said fixtures being installed onto a predefined object.

4. The device defined in claim 3, wherein said fixture is a fastener.

5. The device defined in claim 3, wherein said fixture is a hooker.

6. The device defined in claim 3, wherein said fixture is a snapper.

7. The device defined in claim 1, wherein said main body is externally coated by a fabric layer.

8. The device defined in claim 1, wherein said fuel cell stack is horizontally placed in series.

9. The device defined in claim 1, wherein said fuel supplier is a metal hydride tank or an alcohol tank.

10. The device defined in claim 1, wherein the said fuel supplier is externally provided with a fuel indicator.

11. The device defined in claim 1, wherein said main body is externally fitted with a DC socket, which is linked to said fuel cell stack, serving as a DC outlet of said fuel cell stack.
